(19) United States
(12) Patent Application Publication
(10) Pub. No.: US 2023/0385100 A1
(43) Pub. Date: Nov. 30, 2023

(54) COMPUTER SYSTEM USING ENERGY BARRIER INSTRUCTIONS

(71) Applicant: ONiO AS, Oslo (NO)

(72) Inventor: Vemund Bakken, Oslo (NO)

(73) Assignee: ONiO AS, Oslo (NO)

(21) Appl. No.: 17/752,860

(22) Filed: May 25, 2022

(51) Int. Cl. G06F 9/48; G06F 9/52; G06F 1/329

(52) U.S. Cl. CPC G06F 9/4881; G06F 9/522; G06F 1/329

(57) ABSTRACT

Described herein is a computing system comprising: a processing unit; and a program memory associated with the processing unit; wherein the processing unit is configured to retrieve from the program memory and execute instructions specifying one or more operations and at least one energy barrier instruction, the energy barrier instruction comprising a threshold energy, wherein the energy barrier instruction, when executed, causes the processing unit to: request a first indication that the threshold energy is currently available; if the first indication is received, execute the one or more operations: if the first indication is not received, enter an energy conserving mode. Also described herein is a method for operating a computing system.

The present invention relates to a computing system using one or more energy barrier instructions, and in particular to a computing system comprising a processor configured to execute a set of instructions including an energy barrier instruction, which is stored in program memory. A method for operating a computer system using one or more energy barrier instructions is also described.

A traditional computing system includes at least a CPU, memory, various peripheral input/output devices, and software including an operating system and one or more applications to be run. The CPU is associated with a number of memory blocks, including at least one volatile or RAM memory block and at least one non-volatile memory bock, with CPU code (itself stored in the program memory) comprising a set of instructions which cause the CPU to read data from the memory (load), write data to the memory (store), and to perform various additional operations on the data retrieved.

Comprised as part of a traditional operating system is a “scheduler”, representing an operating system module, which controls the order of execution of processes by the CPU, and which in many cases is configured to pause processes and rearrange the order in which processes are to be completed. In larger computing systems, it is the scheduler that utilizes the majority of the processing power required to run the system. The algorithms used for scheduling will depend on expected use and predicted performance of the system, but in a simple case processes are allocated computing power based on a round-robin approach. Complex systems usually use much more sophisticated scheduling algorithms which are able to take into account the relative importance of the different processes, memory requirements, and so on.

The scheduler organizes the processes which are to be run, each of which includes a number of separate operations, in a queue, and can be configured to forward the process at the head of the queue for execution whenever the CPU is in an idle state (non-pre-emptive scheduling). In some cases, the scheduler can have the ability to interrupt a current process in order to start a new process based on priority (pre-emptive scheduling). Processes or tasks are generally organized and sent for execution by the scheduler with reference to memory requirements and availability, meaning that the order can be adapted to a degree depending on whether sufficient memory is available to run a particular process or not. Each process is made up of a plurality of instructions organized as a list, to be run in turn, but the instruction set can include an instruction to jump to a non-adjacent instruction depending on certain requirements being met.

The CPU, and other processing cores within a computing system if several are present, comprise the hardware required to execute the processes making up an application program. The instructions corresponding to each process are stored in memory coupled to the CPU. The CPU retrieves, decodes, and executes the relevant instructions from the memory when instructed by the scheduler to do so (when it is the turn of that particular program to execute one or more operation instructions associated with a particular task).

The interaction between a scheduler and the CPU in a computing system introduces a degree of complexity, and means that any addition, deletion, or change to the application code to be executed by the CPU requires additional adaptation of the scheduler itself in order to account for these changes. It is often different members of a team working on adapting the different components, which means it can be difficult to co-ordinate changes and ensure that the system continues to operate in the most efficient way. The scheduling process is also generally carried out on the assumption that sufficient energy will be available from a power source associated with the system to complete the tasks required. If this is not the case then one or more tasks may fail, which can require reconfiguration or resetting of the memory, and which often ends up being more energy intensive overall.

WO-A-2019/014321 describes an IOT device which is referred to as energy aware. This alludes to the fact that the system includes a scheduler which forwards tasks or processes (each including multiple operations) to the CPU only when it is judged that there is sufficient energy available to the system. This solution does take into account energy requirements to run tasks, but implementation is via an external scheduler, which greatly increases complexity and means that any changes in applications to be run will result in additional changes being required to the scheduling software.

According to a first aspect of the present invention, there is provided a computing system comprising: a processing unit; and a program memory associated with the processing unit; wherein the processing unit is configured to retrieve from the program memory and execute instructions specifying one or more operations and at least one energy barrier instruction, the energy barrier instruction comprising a threshold energy, wherein the energy barrier instruction, when executed, causes the processing unit to: request a first indication that the threshold energy is currently available; if the first indication is received, execute the one or more operations: if the first indication is not received, enter an energy conserving mode.

Both the instructions specifying the one or more operations and the at least one energy barrier instruction are stored in and retrieved, by the processor, from program memory. Energy barrier instructions are included in the program code itself, and the or each energy barrier instruction represents an additional instruction in the program. If the first indication is not received (i.e. within a specified length of time or at the next clock cycle), the energy conserving mode will be entered. The one or more operations to which the energy barrier instruction relates are the one or more operations that are executed subsequent to the energy barrier instruction if the first indication is received. These also represent the one or more operations which require the threshold energy to run, or are estimated to require the threshold energy to run. These will therefore be a set of operations which are always run consecutively and directly following the energy barrier instruction (although there may be a pause in between while the system waits for enough energy to become available). This set of one or more operations can be critical and therefore need to completely execute, without interruption, in one atomic run, once execution has started. The set may comprise more than one operation.

The energy barrier instruction and the operation instruction(s) to which the energy barrier instruction relates are logically stored together in the same program memory, the programme memory can in some cases be one contiguous piece of memory storing programmes to be run by the CPU. The energy barrier instruction represents an additional operation which can be easily included as part of a traditional program provided that the CPU is configured to decode and execute this instruction. A developer, when writing a program, simply needs to add an energy barrier instruction preceding any operation or set of operations which need to complete without interruption, and which require a certain amount of energy in order to do so. Whether the operations are critical enough to require an associated energy barrier instruction will be decided by the developers themselves when the program is initially written, or at a later stage during adaptions to the program code.

There is no need for additional changes to an associated scheduler, and in fact no scheduler is required to be included as part of the system at all. Commonly, no scheduler will be present as part of the computing system. The processor itself will be adapted to decode and execute the energy barrier instruction in that the energy barrier instruction will form a part of the processors “instruction set” (i.e. the instruction set of the processor, which may be a CPU, is extended to include an energy barrier instruction). The actual energy barrier instructions used in each program, and interspersed with the operation instructions therein, may include different values of parameters such as the energy threshold or the specific energy conserving mode to enter if the first indication is not received, but only one additional entry in the instruction set, which is hard-coded into the CPU, is generally required.

The invention is extremely easy for a developer writing an application to implement or to adapt at a later stage, and the system will find particular utility in low power systems coupled to renewable energy sources, because it provides a simple way to account for energy requirements in a system where ample energy to carry out certain operations may not always be available.

Retrieving and executing operations refers to retrieval of instructions from the program memory at a defined location, and adaption of hardware of the processor (i.e. including logic circuits) in response to the retrieved instructions. The operations may be arithmetic operations, and/or may relate to the function of various peripherals such as wireless communication devices. Examples of operations are an instruction to “store” data to memory, to “load” data from memory, to perform an algorithmic or logical operations, and so forth.

In embodiments, the processing unit comprises a decode unit configured to decode both the energy barrier instruction and the instructions specifying the one or more operations. The decode unit supports the energy barrier instructions and the instructions specifying the one or more operations and the CPU is able to fetch, decode, and handle both the operation instructions and the energy barrier instruction itself, without the requirement of an additional processor or a scheduler of any sort. The energy barrier instruction, as for the operation instructions forming part of the programme being run by the CPU, is executed as binary by the CPU.

In embodiments, the processing unit comprises a register file and an algorithmic logic unit. The processing unit is therefore capable of itself executing algorithmic operations retrieved from program memory. In embodiments, the processing unit comprises one or more of a fetch unit, a load/store unit, and a change of flow unit. Any combination of one or more of these components may be included, but generally all of these will be present as part of the processor. The ALU allows adaption of logic gates to execute the instructions, the fetch unit locates the next instruction to be executed and retrieves this from memory, the CPU decoder unit decodes the instruction for execution, the load/store unit extracts and stores information for or resulting from the operations in memory, and the change of flow unit controls where the next instruction is fetched from (for example if a jump is included and the next instruction is not simply a subsequent instruction in a list of instructions forming the program). An “instruction set”, where this is referred to herein, is a set of instructions that the CPU is hard-coded to be able to decode and execute. This instruction set therefore defines the possible operations executed by the CPU.

In embodiments, the processing unit is a core processing unit, or a main processing unit, configured to run the operations stored in the program memory. The system may include a number of processing units associated with different power domains as part of the system, which may be a system on chip (SOC). Some or all of the processing units may be able to function as the main/core processing unit of the invention. Each is operable to execute operations stored as program code, forming part of one or more applications, within a program memory associated with the respective processing unit. Each of the processing units may include one or more of an algorithmic logic unit, load/store unit, change of flow unit, fetch unit, register file, and decoder unit.

In embodiments, if the first indication is not received, the energy barrier instruction causes the processing unit to wait in energy conserving mode until a second indication is received that threshold energy has become available, and to exit energy conserving mode and execute the one or more operations in response to receipt of the second indication. In this way the operations are executed as quickly as possible, as soon as the required energy has become available. The first and second indications can have the same or a different format, i.e. a binary signal or a combination of binary signals sent along one or more wires.

In embodiments, the computing system comprises a power management unit (a PMU) configured to receive the request from the processing unit, determine whether the threshold energy is available, and return the first or second indication when it is determined that the threshold energy is available. In energy conserving mode, it may be only the power management unit which remains active, while the processing unit is inactive. The PMU may also have reduced function and may only, in this case, monitor energy entering the system in order to send the second indication at the correct time.

In embodiments, the computing system comprises an energy storage unit for supplying energy to the processing unit. In embodiments, determining whether the threshold energy is available by the power management unit comprises determining whether the threshold energy is present on the energy storage unit. This represents a simple way to keep track of energy available to the system.

In embodiments, the threshold energy of the energy barrier instruction is configurable. The threshold energy may be configurable by the processing unit. The threshold energy for each energy barrier instruction may be set when the computing system is turned on, and may remain the same until the system is switched off, or may be updated one or more times while the system is running. The initial value may be a default, and may be the same or different for different energy barrier instructions. If the initial value is different for different instructions, this may depend on the type of operation or operation set that the energy barrier instruction relates to. The initial value may be selected manually by the developer themselves when the programme is written, or selected manually on start-up in some cases (such as in response to a prompt). This can then remain the same or be updated, as described above.

In embodiments, the threshold energy represents an amount of energy required to execute the one or more operations or an estimate of the amount of energy required to execute the one or more operations. In embodiments, the processing unit is configured to run the one or more operations, to measure an amount of energy required to execute the one or more operations, and to adapt the threshold energy to the amount of energy measured (i.e. using profiling or dynamic code analysis). The threshold may be updated only once on startup, or each time the operation or operation set associated with the energy barrier instruction is run, for example as a moving average or as the value measured for the most recent execution.

In embodiments, the threshold energy represents an estimate of the amount of energy required to execute the one or more operations, and the amount of energy is determined using static code analysis or manually by analyzing the code. If this is the case, the threshold will not change unless the code itself is changed. Other methods for estimating the energy required to execute an operation or a set of operations can be used.

In embodiments, the computing system comprises a counter (which may be an accumulator) configured to increment every time a fixed amount of energy is added to the energy storage unit and decrement every time the fixed amount of energy is removed from the energy storage unit. In embodiments, the computing system comprises a sensor for measuring an amount of energy added to the energy storage unit from a power source. The accumulator may be the sensor, or an additional separate sensor may be included. The accumulator or sensor may be configured to send an indication to the PMU or processor each time an energy packet is added or removed from the energy storage unit. If an accumulator is used, this may also be used to transfer energy from a power source to the energy storage unit and/or to transfer energy from the energy storage unit to the circuits of the computing system.

In embodiments, the energy barrier instruction comprises a plurality of fields, and one of the plurality of fields includes the energy threshold. In embodiments, the energy barrier instruction comprises a plurality of fields, and one of the plurality of fields includes a type of the energy conserving mode. The type of the energy conserving mode refers to how the system should behave in order to save energy while in energy conserving mode. This may comprise a reduced function for one or more of the components of the system, such as the processor.

In embodiments, the energy conserving mode comprises one or more of a state in which memory is retained, a state in which the clock is stopped (static logic), a complete shut-down of the system, and switching off of RAM. In an embodiment, entering the energy conserving mode comprises stopping the clock used for timing the execution of operations (the CPU clock). In some cases, during energy conserving mode, the only active part of the system will be a power management unit which will continue monitoring energy entering the system, and which will send the second indication when it is determined that the threshold energy has become available. The clock can restart once the second indication is sent, at which point the one or more operations can be executed. While the clock is stopped, the voltage supply to the electronics of the CPU can be reduced to minimize energy usage. If the voltage reduces to a point where it is no longer possible to maintain the state/context of the CPU in volatile memory, the system can completely shut down, in which case the state is stored in non-volatile memory, where it can be retained until start-up. Entering the energy conserving mode (unless a minimum voltage level is reached) will not therefore require storing of the state of the CPU in non-volatile memory. Restarting operations when the second indication is received will equally not require any additional loading operations to be completed, making the system extremely energy efficient. In embodiments, the processing unit is a core or main processing unit.

In embodiments, the computing system is a monolithic system on chip comprising a plurality of blocks including: the processing unit and the program memory. The computing system in this case is an SOC, and can be formed as a contiguous piece of silicon comprising all of the elements of the system. This means that the system can be used as part of a lightweight, low energy, device, such as a non-wearable or wearable device for monitoring the device surroundings or a wearable device for monitoring the bodily function of a subject.

According to a second aspect of the present invention, there is provided a method for operating a computing system comprising a program memory and a processing unit configured to retrieve and execute instructions specifying one or more operations which are stored in the program memory, the method comprising: retrieving from the program memory and executing, by the processing unit, an energy barrier instruction specifying a threshold energy; requesting, by the processing unit as a result of executing the energy barrier instruction, a first indication that the threshold energy is currently available; if the first indication is received, executing, by the processing unit, the one or more operations: if the first indication is not received, entering, by the processing unit, an energy conserving mode.

In embodiments, the energy storage unit is configured to receive and store energy from a renewable power source. The energy stored may derive from any one or more of solar energy (the sun), body heat, kinetic energy, radio, and so on. The renewable source itself can be any one or more of a photovoltaic (PV) cell, a radio frequency energy harvester (an RF source), a piezoelectric element, or a thermal energy harvesting element.

Embodiments of the present invention will now be described, by way of example only, with reference to the following diagrams wherein:

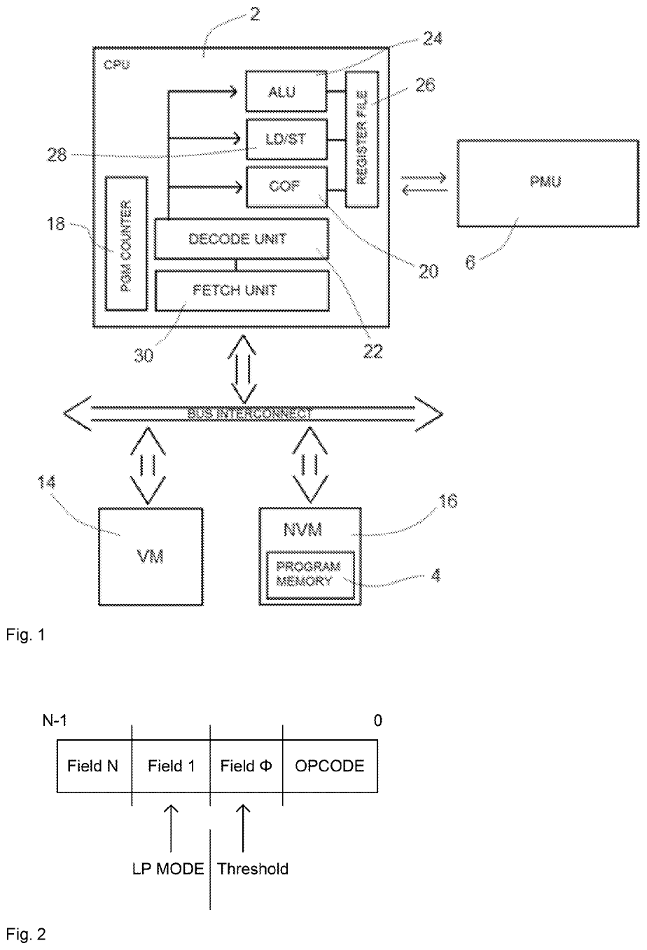

FIG. 1 illustrates how components of a computer system interact;

FIG. 2 shows an example of an energy barrier instruction;

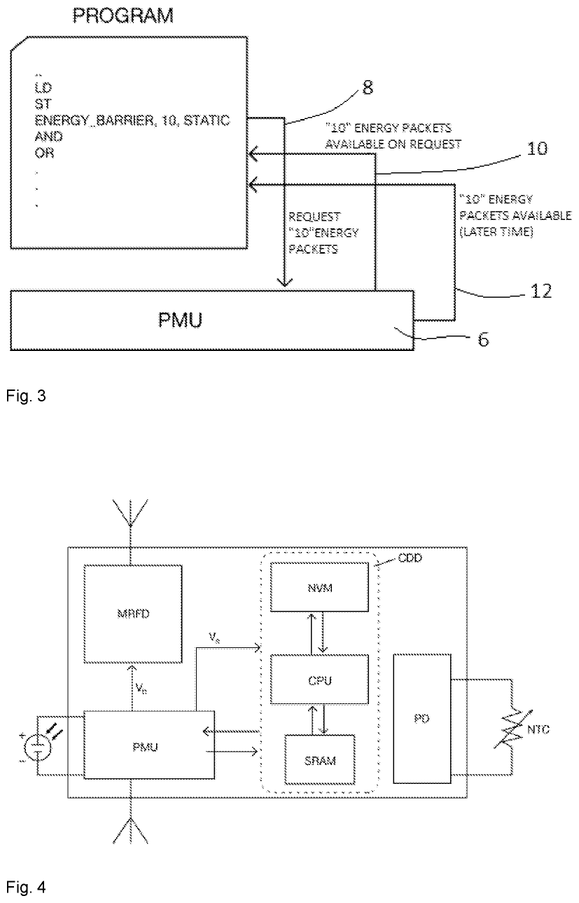

FIG. 3 shows requests sent to the PMU as a result of running the energy barrier instruction by the CPU; and

FIG. 4 illustrates an example computing system in energy barrier instructions can be implemented.

FIG. 1 illustrates the central units making up the computing system described herein. The core or main processing unit (CPU) 2, and specifically a fetch unit 30 of the CPU, retrieves program instructions from a particular address in an associated program memory 4, which represents all or part of the non-volatile memory 16 (usually flash). The CPU decodes and executes these instructions in order to carry out the operations specified therein. The results of any operations run may be saved in the same or a different memory block. Specifically, the CPU 2, and other similar processing units of a computing system if present, are configured to retrieve a set of instructions making up a process from a corresponding set of memory addresses in the program memory 4. The address of the next instruction to be retrieved can be determined by a program counter 18 which increments each time an instruction is executed. Each instruction relates to a particular operation to be carried out by the processing unit as part of the application being run. If jumps are to be included, these can be specified as part of an operation and are dealt with by the change of flow unit 20 in the CPU. Once retrieved from memory, the instruction is decoded by a decode unit 22 and executed, the program counter 18 is incremented, and the next instruction is read from the next specified memory address in the program memory 4. In order to be able to execute the instructions, the processor comprises an algorithmic logic unit 24 for executing logical operations (for example arithmetic operations). Load or store instructions are dealt with by a load/store unit 28. The register file 26 provides temporary storage in the processor, and is used to hold data during execution of operations.

The power management unit (PMU) 6 controls power usage for the system. The PMU is in communication with the CPU to provide requested information about available energy, in order to allow the CPU to control execution of operations based on this information, as will be described in more detail below. The CPU itself is therefore energy conscious, and is able to account for energy availability, which is not so for traditional systems and those relying on a scheduler to determine when the different operations of the program are to execute. Communication between the CPU and PMU is two-way, as shown in the figure. Requests are sent by the CPU for permission to execute a particular operation, and indications are returned by the PMU when sufficient energy is available.

As mentioned, and in contrast to traditional computing systems, the present system does not include a separate scheduler to organise the order in which processes are executed by the processor based on memory requirements. Instead, sufficient memory space to run any process is assumed, and the processes are run based on an order indicated in the program instructions retrieved by the processor (i.e. using a program counter).

In order to allow the system to account for variation in the level of available energy, the usual set of one or more instructions to be executed are preceded in the program code itself by an additional instruction referred to herein as an “energy barrier instruction”. The energy barrier instruction causes the CPU to send a message to the PMU requesting permission to run a set of one or more instructions which logically directly follow the energy barrier instruction in the code. The set of one or more instructions may follow the energy barrier instruction in that they make up the subsequent lines of program code. Alternatively, they may comprise the next one or more instructions to be executed based on pointers in the code, so that they do not make up adjacent lines of code in the program, but will be executed as a set of consecutive instructions as a result of parameters set out in the code. In both cases these instructions are referred to as subsequent instructions associated with the energy barrier instruction.

The energy barrier instruction will cause the CPU, on executing the instruction, to request a first indication from the PMU that a certain amount of energy is available. This first indication will represent permission for the CPU to continue with executing the subsequent instructions associated with the barrier instruction. The amount of energy will represent a threshold amount of energy required to execute the instructions associated with the energy barrier, and will be included as part of the energy barrier instruction itself. The PMU may, as a result of the request, compare this specified threshold energy value with a received energy value to determine whether or not this threshold value is met or exceeded by the received value. If the threshold is met or exceeded, the PMU will send the requested first indication to the CPU that the energy is available, and the CPU will continue in response to receipt of the indication by retrieving the subsequent instruction from memory and executing this. Whenever an energy barrier instruction is encountered in the program code, the comparison will again be carried out. Usually, and provided that sufficient energy is available to do so, the processor will continue to run instructions, line by line, or in the order in which they are specified in the code until the next energy barrier instruction is encountered. This may be the case even after the instructions associated with the previously executed energy barrier instruction have all been executed. The CPU will also attempt to execute any subsequent instructions, but may be interrupted if sufficient energy is not available. Because the subsequent instructions are not associated with an energy barrier instruction, it can be assumed that it is not as crucial that these fully execute without interruption.

There may be a plurality of energy barrier instructions within the program code. In some cases, all operations within the program which do not represent an energy barrier instruction themselves may be associated with an energy barrier instruction. Alternatively, only some of the operation instructions may be associated with an energy barrier instruction, in which case these will represent an operation or a set of consecutive operations which must be completed without interruption. The threshold energy value can be different for the different energy barrier instructions within a particular application or program. The threshold can depend, for example, on the subsequent instructions associated with that instruction, whether it is crucial that these be executed without failure, and how much energy is required for them to execute. The threshold will in most cases correspond to an amount of energy required to execute one or more subsequent instructions which need to be executed in turn and without failure. The threshold may correspond to the minimum energy required to execute this particular set of instructions, or in some cases to execute all instructions between the current energy barrier instruction and the next energy barrier instruction in the program code.

An example of a possible format for an energy barrier instruction is shown in FIG. 2. The instruction includes a number of fields including a first data field (“field 1”) which includes information regarding an action to be taken if indication is not received from the PMU that the threshold energy is available (i.e. the first indication is not received within a set time period or in the next clock cycle). This action may comprise entering an energy conserving mode until a second indication is received that the threshold energy has become available. The second indication will only be sent if the first indication is not received, and will be sent only after the system has entered into the specified energy conserving mode as a result of the first indication not being received. Field 1 may specify which type of energy conserving mode the system should enter (i.e. complete switch-off, static mode in which the CPU clock is stopped, or another low-power mode). As mentioned above, a preferred energy conserving mode comprises switch off of the CPU clock and reduction in voltage supply until the second indication is received. In this case it is not necessary to load a state of the CPU into non-volatile memory before the energy conserving mode is entered and no additional energy is used in order to enter or exit this mode. Field ϕ in the example shown is where the energy threshold information is stored. For the example shown in FIG. 3, where “10 energy units” are requested from the PMU, this threshold will be specified as 10 energy units in field ϕ. Another field of the energy barrier instruction comprises the operation code which sets out the actions to be taken by the CPU. The operation code may specify the following actions: “request [amount of energy specified in field ϕ] from PMU”; “if a first indication is received that the energy is available proceed to run subsequent instruction”; “if indication is not received carry out action specified in [field 1]”; and “wait for a subsequent (second) indication that energy units are available”. The subsequent indication may be received as soon as the required 10 energy units are available, and may represent the second indication. The first and second indications may be of the same type and/or may be identical.

FIG. 3 illustrates part of a program, which will be stored in the program memory of the system, including an energy barrier instruction. In this case the energy barrier instruction precedes a set of instructions including at least an “AND” instruction and an “OR” instruction. Before executing these subsequent instructions, the CPU (as a result of executing the energy barrier instruction) sends a request 8 to the PMU for an indication that 10 energy packets are available. If the PMU determines that the required number of energy packets are available, a first indication 10 is returned. If the PMU determines that fewer than 10 energy packets are available, either a negative indication is returned (not shown in the figure) or no indication is returned, and the CPU enters static mode as specified in the energy barrier instruction. In order for the CPU to exit static mode and proceed with running the subsequent instruction, the PMU needs to send a second/later indication 12 that the threshold energy has now become available. This will generally happen as soon as the threshold energy becomes available for supply to the CPU. Obviously, the first and second indications will not both be sent. Either the first indication is sent, or the second indication is sent after a certain length of time, and usually after the CPU has waited in an energy conserving mode throughout this time.

Determination by the PMU as to whether the threshold energy is available can be based on a comparison with a received energy value, as mentioned. This can represent all or part of the energy available at an energy storage unit for providing energy to the processor configured to execute the energy barrier instruction and the subsequent operations. The system may, for example, comprise a main energy storage unit such as one or more capacitors or batteries, coupled to a sensor configured to monitor the level of energy stored thereon. An indication of the level of energy available at the storage unit, as measured by the sensor, can be utilised for the comparison by the PMU as the received energy value. In some cases, the received energy value can correspond to a proportion of the total energy available on the energy storage unit. This may be the case if energy on the energy storage unit is to be distributed to more than one application for simultaneous execution, and another program of higher priority has requested an amount of energy to run. The system may also comprise more than one energy storage unit serving different processors, so that the received energy value can correspond to all or a proportion of the energy available on the particular energy storage unit powering the processor in question. If two programs request energy at once, the PMU can allocate a priority to each of these programs. Energy is provided, via the PMU, to the program with highest priority. Very fine-grained control of energy requirements for the system is made possible. The processor stops and requests a small amount of energy each time an energy barrier instruction is encountered in the code. It is also not necessary in such a case to wait for energy to be available to run whole program, but rather only the specific operations which are associated with the energy barrier instruction.

The system can comprise an accumulator as the sensor for monitoring a level of energy available on the energy storage unit. The sensor can function as a counter, incrementing every time a fixed amount of energy (an energy packet) is stored, and decrementing every time an energy packet of the fixed amount is removed. This is particularly straightforward where an accumulator is used as the sensor, since the same fixed amount of energy will generally build up on the accumulator in each storage cycle before being transferred to the energy storage. The accumulator thus provides an indication to the processor, or to a power management unit of the system, of how many energy packets are stored on the energy storage unit at any particular time. The indication can be passed to the PMU at intervals, or in response to a specific request from the PMU or the processor. The request can be sent as a result of the energy barrier instruction being executed.

As an example, when the processing unit executes the energy barrier instruction, and a request for a first indication is sent by the main processing unit to the PMU, the PMU can request that an energy count be returned by the accumulator or associated components. Because a number of energy packets being stored is monitored using the accumulator, rather than the amount of energy on the storage unit itself, the rate at which energy is depleted from storage is not directly measured using the same sensor. The number of energy packets on the storage unit can be inferred, however, based on the number of energy packets being added via the accumulator and the energy required by any processes drawing energy from the storage unit. The PMU will usually be informed when an energy packet is added to the system or when one is removed, so that it will always be aware of an amount of energy available. It may not therefore be necessary for the PMU to send a request in order to respond with a first or second indication to the processing unit executing the energy barrier instruction.

Once the energy threshold is reached to be able execute a set of operations, and the operations are run, it is assumed that all of the energy is used by the execution and the counter decrements by that number of energy packets. The accumulator or other sensor can be connected so as to count energy packets added to the system from a power source. The same or a different sensor (i.e. the same accumulator if this is used to transfer energy away from the energy storage unit, such as to domains of the circuit) may also provide a count of energy packets leaving the energy storage unit.

This configuration is particularly beneficial where the system receives energy from one or more renewable energy sources as the power source, as in the example embedded system described below. The threshold energy value can in this case represent a number of energy packets required to execute the next set of instructions. The power source may be a different energy storage unit of the system, such as a main energy storage unit which supplies energy to domain energy storage units associated with each power domain. The accumulator count can be overseen by the PMU, and the energy barrier instruction can include a direction to retrieve the current count by the power management unit, as explained above.

In some cases, where the threshold is not met or exceeded, the comparison can be carried out at intervals (either periodically or irregularly) until the threshold is met or exceeded, at which point the subsequent instruction will be retrieved from memory. Usually, however, the PMU will be constantly aware of the number of energy packets available on the energy storage unit. The sensor will inform the PMU each time a new packet is added, and the PMU will keep track of how many packets are removed for use in different processes, either using the same or a different sensor, or by other means. As soon as enough packets are available, the PMU will be aware of this and will send out the second indication.

The threshold energy value for each energy barrier instruction can be configurable, and can in some cases be learned by the system itself during one or more initial runs of the subsequent set of instructions (the set of instructions to which the energy barrier relates). The instruction to measure an amount of energy can be part of the operation code of the energy barrier instruction, and this may in some cases also require an indication of how many or which instructions are related to the energy barrier instruction to be included in the instruction itself. The threshold energy value provided as part of the energy barrier instruction can be set initially to zero, for example, so that the processor always attempts to run the subsequent instructions initially (although there is a risk of failure if sufficient energy is not in fact available for full execution). The number of energy packets, or an amount of energy, required to run the full associated group of instructions can be counted and this can be set as the threshold energy amount for subsequent runs. The threshold energy amount can thereafter correspond to a number (N) of energy packets, where an energy packet is a fixed amount of energy and N energy packets were required to run execute the operations associated with the energy barrier instruction.

Instead of setting the threshold energy value to zero initially, this can be set to a predicted value to try to avoid failures during the initial runs. A compiler can also be used to determine N based on static code analysis. N can alternatively be selected when the programme is written by the developer, and can thereafter remain unchanged. Different types of energy barrier instruction can be included in the same program, so that for some the threshold remains fixed, and for others the threshold is adaptive.

There can be a number of processing units present as part of a system on chip, each waiting for a certain number of energy packets to accumulate in order to run a subsequent set of instructions. In such a case a power management unit can serve the processing units on a first come first serve basis, or using some other system involving allocating different priorities to the processing units or the associated applications.

The components of a computer system in which the present invention can be implemented are shown in FIG. 4. The computer system in this case is an embedded system on chip comprising at least four separate blocks including the core logic unit or core digital domain (CDD), a multimode RF domain (MRFD), a peripheral domain (PD), and a power management unit (PMU). The CPU is part of the core logic unit or core digital domain in this case. The core digital domain comprises a CPU, static RAM (SRAM), and non-volatile memory (NVM). The CPU is the processor configured to execute the energy barrier instruction and the one or more consecutive subsequent operations to which the energy barrier instruction relates. The operation instructions and the energy barrier instructions themselves are stored in the programme memory.

The MRFD includes at least one radio frequency transmitter or transceiver for sending and/or receiving data from external or internal devices. This transceiver/transmitter can implement multiple radio protocols such as BTLE and IEEE 802.15.4. The PD comprises circuitry for interfacing with external devices, which may include one or more of a temperature sensor, heart rate sensor, EEG/ECG sensor, blood pressure measuring devices, or any other biometric sensing device. The chip may also include one or more internal sensors which may be comprised as part of an additional block or as part of one of the existing blocks, such as the core digital domain.

The embedded system may in some cases be incorporated into a wearable device, such as a patch, band, or an item of clothing. One particularly advantageous use of the embedded system is for interfacing with a biometric sensor in a wearable patch. The patch may have an adhesive backing for attachment to the skin. The biometric sensor (i.e. a skin or core body temperature sensor) can forward sensor data to the core logic unit. This may be processed by the chip logic and certain actions may be taken in response to a reading that is detected to be above or below a threshold. Information, including sensor data or warnings, can be sent to an external device via a radio transceiver on the chip. Because the device in this case has a crucial health function, and is required to be both lightweight/wearable and reliable, power saving is particularly important. The power saving capabilities of the embedded system described herein are therefore ideally suited to this type of use. The system is also particularly suitable for use with other simple sensing devices, such as heat or humidity sensors with a communicative function.

At least a portion, and in some cases all, of the power to the chip can be provided by renewable energy sources, where a renewable energy source refers to any energy source which is operable to harvest energy from an external environmental source or from the surroundings. The external environmental source from which energy is harvested by the renewable source can be solar energy (the sun), body heat, kinetic energy, radio, and so on. The renewable source itself can be any one or more of a photovoltaic (PV) cell, a radio frequency energy harvester (an RF source), a piezoelectric element, or a thermal energy harvesting element. Selection of a source may be based on available energy from each source, or based on pre-set conditions.

Any renewable source can be utilized, but a combination of at least one PV cell and at least one RF source provides a good coverage in terms of energy availability over a longer time period. The PV cell may be able to provide less input energy at night, for example, at which time the RF source can be more heavily utilised. Because the radio frequency harvester produces an alternating current, a rectifier, such as a wideband rectifier, may be included in the path between the RF source and the rest of the system. The rectifier is capable of converting any time varying signal, i.e. between 400 MHz and 2500 MHz in the case of an RF source, and converting it to a DC voltage. Such a rectifier may be included for any renewable source linked to the chip which has alternating current as an output. The PV cell is operable to take any weak input DC voltage and to store this for subsequent provision to requesting blocks via an inductor, as described below. The rectifier, if present, will be between the source and the inductor.

The chip can include multiple power domains, where each of the power domains on the chip carries out a particular function or set of functions, and requires voltage to perform tasks associated with this function. Some or all of the power domains can be associated with their own separate processor, some or each of which can process energy barrier instructions stored in an associated programme memory as part of an application program to be executed on that power domain. Each of these separate processors can act as the CPU or processing unit described above. The voltages required will depend on the specific tasks to be performed at any time, and will therefore vary based on demand.

As an example, the processor at issue is the processor of the MRFD, and the application code to be run comprises an energy barrier instruction followed by an instruction causing transmission of a data packet. The processor of the MRFD will require energy in order to prepare the data packet for transmission and to send it. The energy barrier instruction will include a threshold based on the energy required by the MRFD to do so, and the processor of the domain will send a request to the PMU for a first indication that this energy is available to it. If it is available, the first indication will be sent and the voltage at the requested level will be provided on one of a number of voltage rails, each associated with its own voltage/power domain on the chip. Once the correct voltage is available on a rail, the PMU will send a message to the processor of the MRFD indicating that the requested voltage is available, at which point the voltage can be drawn through the rail, and the processor can execute the subsequent instructions which will comprise the required logic to prepare and send the data packet. The voltage can continue to be supplied at the requested level by the PMU until the MRFD indicates that it no longer requires energy (i.e. that the task is compete or that a task to be carried out periodically no longer needs to be carried out), at which point the PMU will adjust the switches in the circuit to stop the supply of power on the respective voltage rail. If the energy is not available and the first indication is not sent, the processor of the MRFD can enter an energy conserving mode to wait for a subsequent second indication that the threshold energy has become available. Again, entry of an energy conserving mode in the absence of the first indication and the type of mode to be entered will be specified as part of the energy barrier instruction.

Each of the power domains present can be associated with its own domain energy storage unit, which may be a decoupling capacitor. These capacitors ensure that the requested voltage can be supplied, and can continue to be supplied, on each of the rails. In some embodiments, the PMU controls charging of a main energy storage unit (usually also a capacitor) and transfer of energy from the main energy storage unit to the decoupling capacitors for supply to the power domains of the chip. The different capacitors or storage elements representing the domain storage units can have different properties, and can thus be tailored to provide a voltage at a particular level. In such a case, the PMU will select the correct capacitor to provide the desired voltage in response to a request from a system block. Capacitors are used as the domain and main storage units here, but other energy storage mechanisms can be used in their place. Further, although one storage element (i.e. one capacitor) is allocated as each of the main storage unit and the domain storage units in the example described, two or more energy storage elements can function together as a main storage unit or as a domain storage unit.

Where the system includes a number of power domains each associated with its own application processor and programme memory (and possibly its own energy storage unit), the processor of each domain can function as the CPU in the examples described above to send requests and receive either a first or second indication from the PMU, and the domain storage unit can represent the energy storage unit described above.

1. A computing system comprising:
a processing unit; and
a program memory associated with the processing unit;
wherein the processing unit is configured to retrieve from the program memory and execute instructions specifying one or more operations and at least one energy barrier instruction, the energy barrier instruction comprising a threshold energy, wherein the energy barrier instruction, when executed, causes the processing unit to:
request a first indication that the threshold energy is currently available;
if the first indication is received, execute the one or more operations; and
if the first indication is not received, enter an energy conserving mode.

2. The computing system of claim 1, wherein the processing unit comprises a decode unit configured to decode both the energy barrier instruction and the instructions specifying the one or more operations.

3. The computing system of claim 1, wherein the processing unit comprises a register file and an algorithmic logic unit.

4. The computing system of claim 1, wherein the processing unit comprises one or more of a fetch unit, a load/store unit, and a change of flow unit.

5. The computing system of claim 1, wherein if the first indication is not received, the energy barrier instruction causes the processor to wait in energy conserving mode until a second indication is received that threshold energy has become available, and to exit the energy conserving mode and execute the one or more operations in response to receipt of the second indication.

6. The system of claim 1, comprising a power management unit configured to receive the request from the processing unit, determine whether the threshold energy is available, and return the first or second indication when it is determined that the threshold energy is available.

7. The system of claim 1, comprising an energy storage unit for supplying energy to the processing unit.

8. The system of claim 7, wherein determining whether the threshold energy is available by the power management unit comprises determining whether the threshold energy is present on the energy storage unit.

9. The system of claim 1, wherein the threshold energy of the energy barrier instruction is configurable.

10. The system of claim 1, wherein the threshold energy represents an amount of energy required to execute the one or more operations or an estimate of the amount of energy required to execute the one or more operations.

11. The system of claim 10, wherein the processing unit is configured to run the one or more operations, to measure an amount of energy required to execute the one or more operations, and to adapt the threshold energy to the amount of energy measured.

12. The system of claim 10, wherein the threshold energy represents an estimate of the amount of energy required to execute the one or more operations, and the amount of energy is determined using static code analysis.

13. The system of claim 7, comprising a counter configured to increment every time a fixed amount of energy is added to the energy storage unit and decrement every time the fixed amount of energy is removed from the energy storage unit.

14. The system of claim 1, wherein the energy barrier instruction comprises a plurality of fields, and one of the plurality of fields includes the energy threshold.

15. The system of claim 1, wherein the energy barrier instruction comprises a plurality of fields, and one of the plurality of fields specifies a type of the energy conserving mode.

16. The system of claim 1, wherein the energy conserving mode is one or more of a state wherein memory is retained, a state wherein the clock is stopped, complete shut-down of the system, and switching off of RAM.

17. The system of claim 1, wherein the system is a monolithic system on chip comprising a plurality of blocks including: the processing unit and the program memory.

18. The system of claim 1, wherein the processing unit is a core processing unit.

19. A method for operating a computing system comprising a program memory and a processing unit configured to retrieve and execute instructions specifying one or more operations which are stored in the program memory, the method comprising:
retrieving from the program memory and executing, by the processing unit, an energy barrier instruction specifying a threshold energy;
requesting, by the processing unit as a result of executing the energy barrier instruction, a first indication that the threshold energy is currently available;
if the first indication is received, executing, by the processing unit, the one or more operations:
if the first indication is not received, entering, by the processing unit, an energy conserving mode.

20. The computing system of claim 2, wherein the processing unit comprises a register file and an algorithmic logic unit.
